(19) United States
(12) Patent Application Publication
(10) Pub. No.: US 2009/0079403 A1
(43) Pub. Date: Mar. 26, 2009

(54) Apparatus to provide a current reference

(76) Inventors: Jun Xu, Shanghai (CN); Xinwei Guo, Shanghai (CN); Gerald Barkley, Oregon, WI (US)

Correspondence Address: KED & ASSOCIATES, LLP;INTEL CORPORATION, P.O. BOX 221200, CHANTILLY, VA, 20153-1200, US

(21) Appl. No.: 11/902,921

(22) Filed: Sep. 26, 2007

(51) Int. Cl. G05F 1/565

(52) U.S. Cl. 323/269

(57) ABSTRACT

An apparatus is provided that includes a voltage generator to produce a voltage that compensates for temperature variation and a current source that generates a current reference based on the voltage from the voltage generator.

### BACKGROUND

1. Field

Embodiments of the present invention may relate to an apparatus (or circuit) to provide a current reference that is insensitive (or relatively insensitive) to process, voltage and temperature variations.

2. Background

Fabrication of integrated circuits may involve complex processes. The fabrication processes may yield integrated circuit devices that do not operate similarly due to parameter variations, such as process skews and/or operating conditions. For instance, integrated circuits may be susceptible to process-voltage-temperature (PVT) variations.

PVT variations may affect circuit performance such as timing skew. For example, deviations in fabrication processes on a semiconductor die and/or variations in circuit operation may result in PVT variations of varying quantity across the die. These variations may produce local variations in circuit performance. Thus, the generation and propagation of data and control signals may differ on an integrated circuit die.

### BRIEF DESCRIPTION OF THE DRAWINGS

Embodiments may be described in detail with reference to the following drawings in which like reference numerals refer to like elements and wherein:

FIG. 1 is a diagram of an apparatus to provide a current reference in accordance with an example embodiment of the present invention;

FIG. 2 is a plot of voltage versus current depicting current through a pair of transistors of FIG. 1 in accordance with an example embodiment of the present invention; and

FIG. 3 is a diagram of a voltage generator in accordance with an example embodiment of the present invention.

### DETAILED DESCRIPTION

In the following description, like reference numerals and characters may be used to designate identical, corresponding or similar components in different drawings. Where specific details are set forth in order to describe example embodiments, it should be apparent to one skilled in the art that embodiments may be practiced without these details.

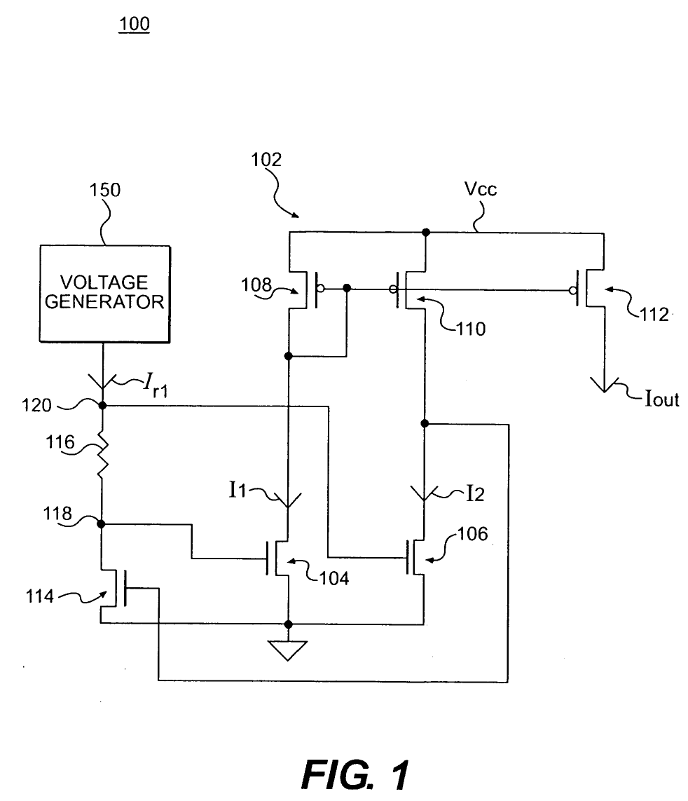

FIG. 1 is a diagram of an apparatus to provide a current reference in accordance with an example embodiment of the present invention. Other embodiments and configurations are also within the scope of the present invention. More specifically, FIG. 1 shows a current reference circuit 100 that includes a current source 102 and a voltage generator 150 (such as a proportional to absolute temperature (PTAT) voltage generator). The circuit 100 may generate a current reference (Iₒᵤₜ) that is insensitive (or relatively insensitive or substantially insensitive) to process, voltage and temperature (PVT) variations.

The circuit 100 may be used in an analog circuit for high performance, low power applications. For example, a stable current reference may be used in applications involving high performance analog circuits. Likewise, in low power applications, a stable power consumption may be achieved through PVT insensitive current references.

A current reference may also be used in analog circuits such as a bias source for oscillators, amplifiers, phase locked loop (PLL) and the like. Analog-to-digital converters (ADCs) and digital-to-analog converters (DACs) may use voltage and current references. On the other hand, phase-locked loops (PLLs) may use time references and current references.

The voltage generator 150 may produce (or generate) a reference voltage that compensates for a temperature variation (or variations). The current source 102 may be a threshold voltage (Vt) independent current source that receives the reference voltage from the voltage generator 150 and generates a current reference that is substantially insensitive (or relatively insensitive) to process and supply voltage variations in the current source 102 (such as in respective transistors of the current source). Accordingly, the current reference is relatively insensitive to process, supply voltage and temperature variations.

The current source 102 may include a first transistor 104, a second transistor 106, a first current mirror transistor 108, a second current mirror transistor 110, a third current mirror transistor 112, a feedback transistor 114 and a resistor 116. Other circuit elements may also be used.

The first transistor 104 may be an N-channel metal oxide field effect transistor (MOSFET) having a source, a drain and a gate. The gate of the transistor 104 may be coupled to a first node 118. The drain of the first transistor 104 may be coupled to a source of the first current mirror transistor 108. The source of the first transistor 104 may be coupled to GROUND. FIG. 1 also shows current 11 flowing into the drain of the first transistor 104.

The second transistor 106 may also be an N-channel MOSFET (or NMOS) having a source, a drain and a gate. The gate of the second transistor 106 may be coupled to a second node 120, the drain of the second transistor 106 may be coupled to the second current mirror transistor 110 and the source of the second transistor 106 may be coupled to GROUND. FIG. 1 also shows current 12 flowing into the drain of the second transistor 106.

The first and second transistors 104 and 106 may have appropriate dimensional and geometrical specifications selected in accordance with an example embodiment of the present invention. More specifically, the first transistor 104 may have a gate width to gate length ratio (W/L) that is different than a gate width to gate length (W/L) ratio of the second transistor 106. As one example, the W/L ratio of the first transistor 104 may be A times greater than the W/L ratio of the second transistor 106. The width (W) and length (L) of each of the first and second transistors 104, 106 may be chosen to minimize (or substantially minimize) process variations of the current source.

One end of the resistor 116 corresponding to the first node 118 may be coupled to the gate of the first transistor 104 and the other end of the resistor 116 corresponding to the second node 120 may be coupled to the gate of the second transistor 106.

The feedback transistor 114 may also be a NMOS transistor having a source, a drain and a gate. The feedback transistor 114 may provide a negative feedback. The negative feedback responds in such a way as to reverse a direction of change. The negative feedback may help maintain stability in the circuit. The drain of the feedback transistor 114 may be coupled to the first node 118, the gate of the feedback transistor 114 may be coupled to the drain of the second transistor 106 and the source of the feedback transistor 114 may be coupled to GROUND. The circuit 100 may attain a stable working condition due to the negative feedback through the feedback transistor 114.

The first current mirror transistor 108, the second current mirror transistor 110 and the third current mirror transistor 112 may each be a P-channel MOSFET (or PMOS) having a source, a drain and a gate. For example, the source of the first current mirror transistor 108 may be coupled to a supply voltage Vcc, the drain of the first current mirror transistor 108 may be coupled to both the gate of the first current mirror transistor 108 and to the drain of the first transistor 104. Likewise, the source of the second current mirror transistor 110 may be coupled to the supply voltage Vcc, the drain of the second current mirror transistor 110 may be coupled to the drain of the second transistor 106 and the gate of the second current mirror transistor 110 may be coupled to the gate of the first current mirror transistor 108 and the drain of the first current mirror transistor 108. The source of the third current mirror transistor 112 may be coupled to the supply voltage Vcc and the gate of the third current mirror transistor 112 may be coupled to the gate of the second current mirror transistor 110, the gate of the first current mirror transistor 108 and the drain of the first current mirror transistor 108. The drain of the third current mirror transistor 112 may provide a current reference Iₒᵤₜ.

The various currents I₁ and I₂ and the current reference Iₒᵤₜ will now be explained. The square law voltage (V) versus current (I) characteristic of a MOS device in saturation may be expressed via mathematical equations. The current (i.e., I1 and I2) through the first and second transistors 104 and 106, respectively, may be expressed by the following Equations (1) and (2):

I₁=½*A*(W/L)*U*C_{OX}*(V_{g1}−Vₜ)² Equation (1)

I₂=½*(W/L)*U*C_{OX}*(V_{g2}−Vₜ)² Equation (2).

In Equations (1) and (2), U represents a charge-carrier effective mobility (or mobility), W represents a respective gate width, L represents a respective gate length, Cox represents gate oxide capacitance per unit area, V_{g1} represents a gate voltage of the first transistor 104 and V_{g2} represents a gate voltage of the second transistor 106. Thus, in a stable condition, the output current reference Iₒᵤₜ may be expressed by the following Equation (3):

Iₒᵤₜ=I₁=I₂=½*A*(W/L)*U*C_{OX}*(Vᵣ₁/(\sqrt{A}−1))² Equation (3),

where Vᵣ₁ represents a reference voltage (i.e., a PTAT reference voltage) across the resistor 116. The output current reference Iₒᵤₜ may be independent of threshold voltages of the first and second transistors 104 and 106. In addition, the gate width (W) and gate length (L) of the first and second transistors 104 and 106 may be specifically chosen to control a differential change in the gate width (dW) and a differential change in the gate length (dL). In addition, mobility (U) may be insensitive to process variations. For example, a doping change of approximately 10% may cause a mobility shift of approximately 2%. However, mobility (U) may have a negative temperature coefficient, The reference voltage Vᵣ₁ may compensate for temperature variation.

A proportional to absolute temperature (or PTAT) circuit or temperature dependent voltage generator may provide a voltage (i.e., the reference voltage) proportional to the absolute temperature. Absolute temperature is a temperature measured relative to absolute zero. The voltage generator may be integrated in a substrate and generate a voltage proportional to an absolute temperature of the substrate.

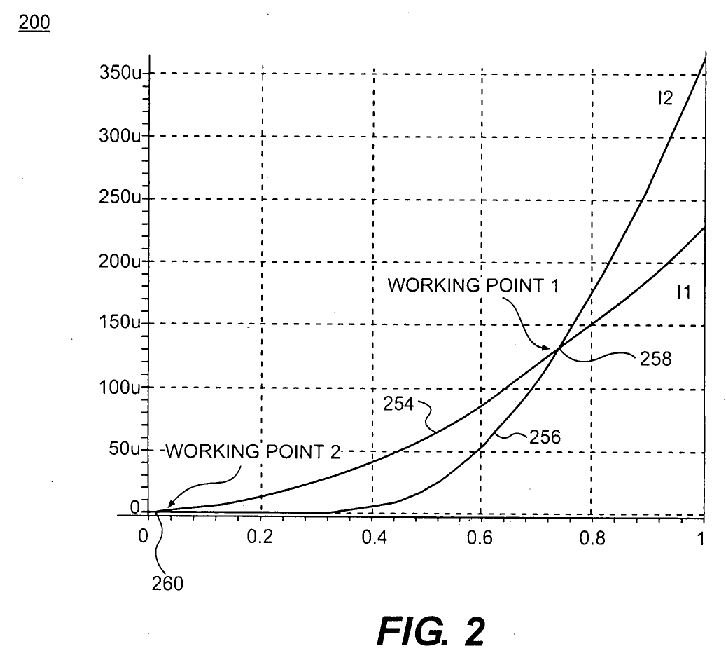

FIG. 2 is a plot of voltage versus current depicting current through a pair of transistors of FIG. 1 in accordance with an example embodiment of the present invention. Other embodiments, configurations and plots are also within the scope of the present invention.

In FIG. 2, the horizontal axis represents voltage and the vertical axis represents current. FIG. 2 shows the current I1 and I2 through the first and second transistors 104 and 106, respectively. As shown in the FIG. 2, currents I1 and I2 form curves 254 and 256 based on Equations (2) and (1), respectively. Equation (3) illustrates a stable condition where the current I1 and I2 are equal to each other. Such a stable condition is shown in FIG. 2 by points 258 and 260 named working point 1 and working point 2, respectively. The working point 1 258 and the working point 2 260 are where the curves 254 and 256 intersect each other.

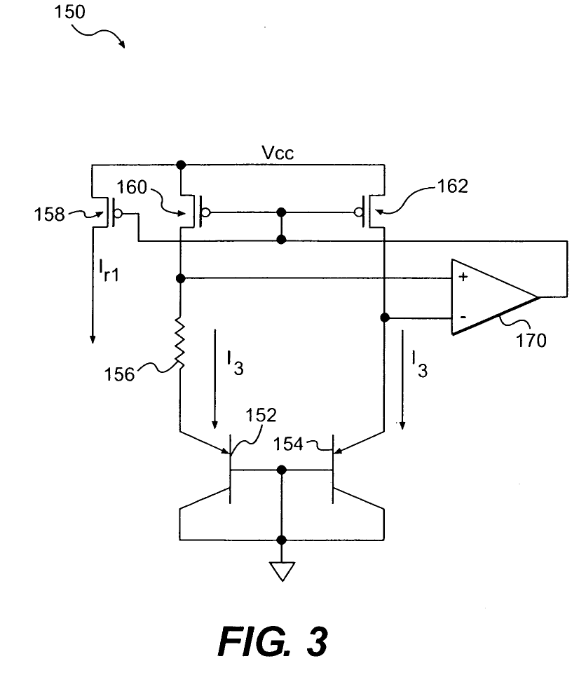

FIG. 3 shows a voltage generator in accordance with an example embodiment of the present invention. Other embodiments and configurations are also within the scope of the present invention. The voltage generator 150 may also be considered a proportional to absolute temperature (PTAT) circuit. FIG. 3 shows that the voltage generator 150 includes a first transistor 152, a second transistor 154, a resistor 156, a third transistor 158, a fourth transistor 160, a fifth transistor 162, and an operational amplifier 170. The voltage generator 150 may generate a reference voltage (or PTAT voltage) using the first and second transistors 152 and 154. The voltage generator 150 may provide the current Iᵣ₁ to the current source 102 (shown in FIG. 1).

The first transistor 152 may be a bipolar transistor having an emitter, a base and a collector. Likewise, the second bipolar transistor 154 may be a bipolar transistor having an emitter, a base and a collector. The first transistor 152 may have a size A1 and the second transistor 154 may have a size A2. Sizes A1 and A2 may relate to bipolar transistor size. For example, A1=24*3 μm*3 μm and A2=3 μm*3 μm. Additionally, the resistor 156 may have a resistance R2.

In stable condition, a voltage ΔVbe (base-emitter) may be applied across the resistor 156. This may be due to the different sizes of the first and second transistors 152 and 154. The current in the first and second transistors 152, 154 may be expressed by the following Equation (4):

I₃=1/R₂*(k*T/q)*logₑ(A1/A2) Equation (4),

where R2 represents resistance of the resistor 156, K represents the Boltzmann constant, T represents the absolute temperature and q relates to charge on the electron.

The current Iᵣ₁ in FIG. 3 corresponds to the current Iᵣ₁ in FIG. 1. Thus, the reference voltage Vᵣ₁ (across the resistor 116) may be expressed by the following Equation (5):

Vᵣ₁=Iᵣ₁*R1=R1/R₂*(k*T/q)*logₑ(A1/A2) Equation (5),

where R1 represents resistance of the resistor 116 and R2 represents resistance of the resistor 156. The resistors 116 and 156 may have a same (or similar resistance) in order to have a stable ratio of R1/R2. Thus, the voltage Vᵣ₁ may be proportional to the temperature and may be insensitive (or relatively insensitive) to process and voltage variations. Further, Equation (5) may be used to substitute the value of the reference voltage Vᵣ₁ in Equation (3) so as to obtain Equation (6):

Iₒᵤₜ=½*A*(W/L)*U*C_{OX}*(1/(√A−1)*(R1/R₂)*(k*T/q)*logₑ(A1/A2))² Equation (6).

Accordingly, Equation (6) shows a current reference Iₒᵤₜ that is insensitive (or relatively insensitive) to process, voltage (or supply voltage) and temperature variations based on selection of design parameters.

Embodiments of the present invention may provide an apparatus (or circuit) that generates a reference current using a voltage generator to produce a reference voltage that compensates for a temperature variation (or variations) and a current source to generate (or provide) a current reference that is insensitive (or relatively insensitive) to process and supply voltage variations of the current source.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus comprising:
a voltage generator to produce a reference voltage; and
a current source to receive the reference voltage from the voltage generator and to generate a current reference that is substantially insensitive to process and supply voltage variations of the current source.

2. The apparatus of claim 1, wherein the current source includes a plurality of transistors, a plurality of current mirror transistors, and a feedback transistor.

3. The apparatus of claim 2, wherein the current reference is independent of threshold voltages of the plurality of transistors.

4. The apparatus of claim 2, wherein a gate width to length (W/L) ratio of a first one of the plurality of transistors is larger than a gate width to length ratio of a second one of the plurality of transistors.

5. The apparatus of claim 2, wherein a width and a length of a gate of each of the plurality of transistors are chosen to minimize process variations.

6. The apparatus of claim 2, wherein the feedback transistor to provide a negative feedback.

7. The apparatus of claim 1, wherein the voltage generator to produce the reference voltage that compensates for a temperature variation.

8. The apparatus of claim 1, wherein the voltage generator comprises a pair of bipolar transistors and a resistor.

9. The apparatus of claim 8, wherein a size of a first one of the bipolar transistors is different than a size of a second one of the bipolar transistors.

10. An apparatus comprising:
a voltage generator to provide a voltage that is relatively insensitive to a temperature variation; and
a current source to receive the voltage from the voltage generator and to provide a current reference, the current source including a plurality of transistors, and a gate width to length ratio of a first one of the plurality of transistors is larger than a gate width to length ratio of a second one of the plurality of transistors.

11. The apparatus of claim 10, wherein the current reference is relatively insensitive to process and supply voltage variations of the current source.

12. The apparatus of claim 10, wherein the current reference is independent of threshold voltages of the plurality of transistors.

13. The apparatus of claim 10, wherein the current source further includes a plurality of current mirror transistors, and a feedback transistor.

14. The apparatus of claim 13, wherein the feedback transistor to provide a negative feedback.

15. The apparatus of claim 10, wherein the voltage generator comprises a pair of bipolar transistors and a resistor, and a size of a first one of the bipolar transistors is different than a size of a second one of the bipolar transistors.
